(19) United States
(12) Patent Application Publication
(10) Pub. No.: US 2007/0076700 A1
(43) Pub. Date: Apr. 5, 2007

(54) Alternative Means for Public Telephone Information Services

(76) Inventor: Christopher O'Donnell, Silver Spring, MD (US)

Correspondence Address: GREENBERG & LIEBERMAN, LLC, 2141 WISCONSIN AVE, N.W., SUITE C-2, WASHINGTON, DC, 20007, US

(21) Appl. No.: 11/609,161

(22) Filed: Dec. 11, 2006

Related U.S. Application Data
(63) Continuation-in-part of application No. 10/449,675, filed on Jun. 2, 2003, now Pat. No. 7,149,294.

(51) Int. Cl. H04L 12/66

(52) U.S. Cl. 370/352; 370/401; 370/261

(57) ABSTRACT

A method is provided for managing network services between a plurality of networks comprising receiving an Internet Protocol data packet with a corresponding address from a first network source, wherein the Internet Protocol data packet comprises a header and a payload and the payload of said Internet Protocol data packet contains at least a portion of a destination address; translating the destination address; and delivering the Internet Protocol data packet to a destination node on a second network based on said translating.

This application is a continuation in part of patent application Ser. No. 10/496675 filed on Jun. 6^{th}, 2003 and Priority is claimed thereto.

### TECHNICAL FIELD

The present invention relates to connecting a calling party with a destination party on a standard telephony network through a variable length communications address.

### BACKGROUND OF THE INVENTION

Currently, telephone voice data is transmitted over a network through paths in digital data packets that traverse routers in the network to arrive at a desired destination over IP protocols. Nowhere in the United States are the old analog switches being used. The current digital switches are, however, still being used in the same fashion as the old analog switches.

When reviewing current telephony technology and use, often, data streams are delivered from a public network to a local node or device in a private network and vice versa. This is only possible because of the new digital switches. As such, telephony services function in the same fashion as IP-based services, which are delivered to or from a local node or device through an entry or exit point of a local network. This entry/exit point functions as a gateway for data so that the public network recognizes a single address for the private network. Typically, Network Address Translation (NAT) is employed to present the private network to the Internet or other public network with one address. In this way, the NAT translates individual IP addresses for each device in the private network for the public network and the private individual IP addresses are concealed from the public network. This results in conservation of addresses and added efficiency of the network interfaces. This is how the current Internet works as well.

As is well known, messages or data being transmitted in networks contain a header and payload. The header is the portion of a message or data that contains information that guides the message to the intended destination. Information contained in the header may include the address of the sender, the address of the receiver, precedence level, routing instructions, etc. Transmitted messages or data further contain a payload portion. The payload portion is in the data portion of the IP packet. An interface between the private network and the public network or Internet must know the mapping between a local node or device and its specific IP address and User Data Protocol (UDP) port to correctly route data to the proper destination. The Network Address Translation (NAT) at the gateway is such an interface. It establishes the said mapping between the private and public networks to interpret address data in the IP headers and delivers any incoming data to the desired local node or device.

However, VoIP protocols sometimes contain address information in the payload (i.e., data portion of the IP packet). One example of such a VoIP protocol is MGCP/NCS (Media Gateway Controller Protocol/Network-based Call Signaling protocol). MGCP/NCS protocol is used for call processing signaling control to provide Voice-over-IP (VoIP) services. In situations where specific IP address information and/or port number information is contained in the payload, the NAT, which only interprets data in the IP header, is unable to properly translate the address information or port number information. As a result, data is not properly delivered to the desired destination in the private network.

Further, the actual voice stream is carried by the Real-Time Transport Protocol (RTP). The IP address and port number information for the RTP packets are defined by the Session Description Protocol (SDP) included in the MGCP/NCS payload and need to be translated properly. In addition, the voice stream, i.e., the RTP packets, need to be routed properly to the intended destination. Therefore, the mapping information is necessary at the gateway for proper routing of data to the correct final destination within the private network. The data packet is delivered to the gateway of the private or local network and the gateway must then route the data to the intended destination within the private or local network. The NAT does not have address mapping information and therefore cannot properly route data to the desired destination node.

Therefore, there exists a need in the art to properly translate address and/or port number information such that VoIP signaling packets are delivered to the desired destination node within a private or local network and public network in a fashion where either voip telephones, cellular telephones or standard land lines will function.

Further, there exists a need in the art to provide address mapping information and actually perform the routing if necessary for delivery of VoIP voice packets to the desired destination node within a private or local network and public network.

### SUMMARY OF THE INVENTION

In one exemplary embodiment of the present invention, a method is provided for managing network services between a plurality of networks having receiving an Internet Protocol data packet with a corresponding address from a first network source, wherein the Internet Protocol data packet comprises a header and a payload and the payload of said Internet Protocol data packet contains at least a portion of a destination address; translating the destination address; and delivering the Internet Protocol data packet to a destination node on a second network based on said translating. The present invention uses a single symbol to denote the type of call and corresponding database.

### BRIEF DESCRIPTION OF THE DRAWINGS

FIG. 1 shows a flow chart of the present invention.

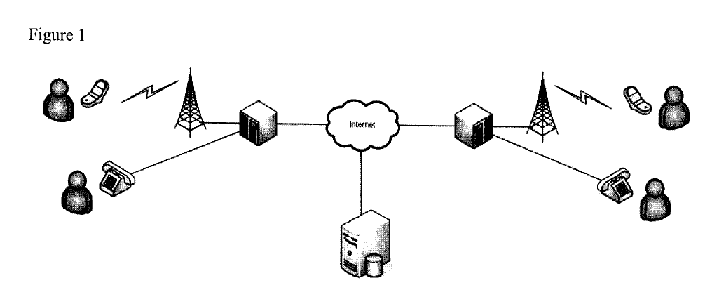

### DETAILED DESCRIPTION OF THE PREFERRED EMBODIMENT(S)

Dialing prefix: Allows the system to recognize that a phone domain is starting (eg. #) Domain: Variable length sequence of digits that is unique to each registrant (eg: 411)

Dialing suffix: Allows the system to recognize that the descriptor has concluded (eg: *)

Domain Extension: A sequence of digits that identifies the type of phone domain (eg: com)

Dialed information (eg: #411*com) is sent to a database where a corresponding registered phone number, URL, fascimile number, etc. is returned. The network provider may then forward the dialing party to the corresponding number. If there is no match, a message notifying the network operator that there is no match is sent. Clearly the # is just one example and the star or any number or sequence of numbers and available signs that are currently are not even currently which can be placed on a telephone key pad may be used. The base of this concept is to use the symbol or number sequence which is not currently being used and instead of using it as routing information directly instead using it to route for particular IP which holds the database that identifies the endpoint based upon all of the information typed (written) into the keypad after that symbol or number sequence.

Phone domain registrar, verifies and directs connection of party one to information content or request query. Information will be shared by carriers, ilec, clec and all partipating telco's. Through a universal database with service providers, allowing the service provider to connect the dialing party with the phone number or other destination information contained in the database.

Registering Domains:

An interface allows registrants to type in desired phone domain and select desired domain extension. This information can be entered as either numbers or letters based upon the standard number to letter conversions that appears on most telephones. The registration system will automatically convert letters to numbers and query the database for availability. If no match is found, the registrant will have the opportunity to purchase the rights to that phone domain for a given length of time. This offer to register is set up as an on-the-fly business opportunity for both the company offering registration and the user.

| Button | Letters |
|---|---|
| 1 | — |
| 2 | a, b, c |
| 3 | d, e, f |
| 4 | g, h, i |
| 5 | j, k, l |
| 6 | m, n, o |
| 7 | p, q, r, s |
| 8 | t, u, v |
| 9 | w, x, y, z |
| 0 | — |
| * | — |
| # | — |

Current Problem:

The current method of reaching another person or business through a telephone is to dial fixed length string of digits. Many business have purchased toll-free numbers (ie. 800, 877, 866, etc.) that resemble their names. For example, DELL has 1-800-WWW-DELL, IBM has 1-800-IBM 4 YOU, and 1-888-SHOP IBM, Google has 650.253.0000. The major problem is that there is no consistency with the naming format of toll-free numbers. Because they are constricted to 7 digits, companies must add or subtract characters from their actual names to make it fit. This then becomes confusing to the customer. Why is DELL 1-800-WWW-DELL and not just 1-800-DELL? The internet has created a system for registering domain names and forwarding them to an IP address. We are proposing a registery for Phone Domains to be forwarded to Phone numbers or URLs (containing directory information). Phone domains will be easier to remember, like Internet domain names.

The Scheme:

The internet generally uses www.DOMAINNAME.com (or net, .biz, .info) The easiest and most practical way to emulate this is to replace www with # and .com with *266 (266 spells “com” on a phone). These characters are universal to phones.

#DOMAINNAME*266

Example: www.DELL.com becomes #DELL*com. www.NetFlix.com becomes #NetFlix*com

Process

Register Phone Domain with forwarding phone number or contact URL.

Inbound phone domain→outbound phone number or contact URL page. Contact page can be read back like a speech system.

Connect standard telephone devices through a sequence of numbers, letters and symbols over a standard telco or carrier by rearranging the group of symbols, numbers or letters and connecting to a central database for verification and transfer.

By outlining the symbols or codes in a specific order, for example (us1*rrrrx#co) here by called Phone Domain Name (PDN). Upon connection to a central database the PDN will be verified as to destination of content or to the information for connection to the end party the owner of the PDN.

PDN will allow for any kind of information to be transferred back and forth between the requesting party and the receiving party so long as the information is in digital format.

Information could include directories, files, voice or audible messages, video, bill payments, direction, schedules, or contact lists. Information will not be limited and only be restricted by the potential of the network operator or carrier or socket. Much of this information can be automatic with variations of the companies trademark returning different information. #IBM could be IBM's main phone number, #IBMsmall could be their small business division, #IBMX40 two return a directory of where to find all X40 new book computer information, etc. services also can be provided in the same fashion as automated information can be obtained, if allowed by the user, through an automated process. For instance #pizzah could be used to order a pizza to be delivered to one's house automatically. User would have previously put their home address into a return address pass some sort and when the above translated IP received a patent it would send back a request for both address and payment information and then, assuming both were available and valid, dispatched a pizza to the requested address. This can be done in other manners, such as sending a text message request back to the telephone that sent the request asking for the necessary information. In cell phone data of other sorts could also be used for automated requests, such as #home could gather the cell phones current location through the currently ubiquitous GPS function in return an automated map of how to use your can travel from their current location to their previously entered home. The possibilities are of course endless and all examples could not possibly listed herein.

Connection will be or can be made through a standard telephone operator, ILEC, CLEC, LEC, MVNO, carrier, IP, or VOIP.

Same as the above claim in addition the connection can be made internal for switching and routing of information to and from a private entity, Government, Military, institution or educational system.

Allow for user to open up a session, which will transfer information between a requestor to the requestee and back again through voice, data, video, SMS, MMS or any combination of any of the initial claims.

Session initiates through a designated grouping of symbols or codes and is completed by designated symbols or codes that end query string.

Any symbol for example 111#aaaa*8

Broken down 111# would be the initiation of the session identifying what type or locatoim of the call.

aaaa would designate the content provider or connection to requested information

* would designate the end of requested session and the 8 would represent the type of information

The symbols numbers and codes could be arranged in any order and sequence and no minimum or maximum amount of characters would change or separate reference when a universal system is applied either for a national, worldwide or interior network was established.

Once session has been established and the information has been transferred for any amount of the duration the call or session request will be disconnected by simply end the call. Or just by hanging up the receiver.

All session requests will be verified by a central database which will verify authenticity of the query string (Phone Domain Name) and upon authorization the call will be transferred and connected the identified registered holder.

All Phone domain names will be registered on a per fee basis and apply to a yearly ownership fee.

I claim:

1. A method reaching a party with a phone number, comprising:
typing a symbol not currently recognized by the telephony system;
typing a text name of a company or entity previously registered by that company;
the telephony system recognizing said symbol and routing all information after the symbol to a particular ip address connected to the telephony system; and
said telephony system acting as a digital gateway/routing system between the entity typing the original symbol and the company owning the text written after said symbol.

2. A method reaching a party with a phone number, comprising:
typing a “#” symbol;
typing an “*” symbol;
typing a text name of a company;
typing an “*” symbol; and
typing a “266” after the text name of the company.
